(19) United States
(12) Patent Application Publication
(10) Pub. No.: US 2018/0194601 A1
(43) Pub. Date: Jul. 12, 2018

(54) Lifting System with PLC and Method Therefor

(71) Applicant: Stertil B.V., Kootstertille (NL)

(72) Inventor: Rudolf Jacobus Antonius Van Houten, Kootstertille (NL)

(21) Appl. No.: 15/741,399

(22) PCT Filed: Jul. 12, 2016
(86) PCT No.: PCT/NL2016/050514

§ 371 Date: Jan. 2, 2018

(30) Foreign Application Priority Data
Jul. 14, 2015 (NL) 2015163

(51) Int. Cl. B66F 3/46

(52) U.S. Cl. CPC B66F 3/46

(57) ABSTRACT

There is proposed a lifting system for lifting a vehicle, which system includes a frame with a carrier configured for carrying the vehicle; a drive for driving the carrier in at least one of the ascent or descent of the carrier; and a power line connection for providing power to the lifting device. The lifting system further includes a control system configured for establishing communication with one or more of the lifting devices. The communication includes power line communication. There is also proposed a method of using said lifting system.

The invention relates to a vehicle lifting system, and more specifically to a lifting system comprising a number of lifting devices, such as lifting columns. These vehicle lifting systems are used for lifting trucks, busses and other vehicles.

Such lifting column or lifting device is known from practice and comprises a frame with a carrier that is connected to a drive for moving the carrier upwards and downwards. In the ascent mode, hydraulic oil is pumped to a cylinder for lifting the carrier and, therefore, the vehicle. In the descent mode, the carrier with the vehicle is lowered and hydraulic oil returns to the reservoir. Such lifting device is disclosed in EP 1 674 422, for example.

In practice, both wired and wireless lifting systems are used. Wired communication provides a robust communication of information, instructions etc. Wireless communication between lifting columns provides optimal flexibility in case of mobile lifting columns. Usually, lifting columns are used in workshops and are often subjected to noise and disturbances that may influence wireless signals.

An object of the invention is to obviate or at least reduce some of the above problems and to provide an effective exchange of information and instructions.

This object is achieved with a lifting system for lifting a vehicle according to the invention, the lifting system comprising one or more lifting devices, each lifting device comprising:
a frame with a carrier configured for carrying the vehicle;
a drive for driving the carrier in at least one of the ascent or descent of the carrier; and
a power line connection for providing power to the lifting device,
wherein the lifting system further comprises:
a control system configured for establishing communication with one or more of the lifting devices,
wherein the communication comprises power line communication.

The lifting system comprises a number of lifting devices. Preferably, the lifting devices relate to lifting columns that preferably operate in pairs. For example, a passenger car can be lifted by two pairs of lifting columns, while a bus or truck can be lifted by six, eight or even more lifting columns. Preferably, each lifting column comprises a carrier moveable along a frame, a (hydraulic) cylinder coupled to the frame as a drive with a motor-pump assembly for at least the ascent or descent of the carrier relative to the frame, preferably correction means for correcting the height of the carrier in response to a measured height difference, a descent valve, and a power connection.

The control system of the lifting system determines and communicates required control actions to the individual lifting devices, particularly the individual lifting columns. The control system comprises computing means, such as a processor, to determine the required and/or desired control actions. This may involve comparing height measurements for different lifting columns and calculating a corrective action, if necessary. According to the invention, the control system can be provided on one of the individual lifting devices, or a selected control system of an individual lifting device, or a separate central controller, or a distributed control system. It will be understood that independent of the physical position/location of the control system, the system requires communication between individual lifting devices. This communication involves measurement information and control instructions. Depending on user preferences different types of user interfaces can be provided to the control system, including a touchscreen, handheld device, app or mobile phone or tablet etc.

According to the present invention, lifting devices comprise a power line connection for providing power to the lifting device. Such power line connection preferably enables application of three-phase currents, and also preferably comprises an earthing or grounding system. This enables providing energy to the individual lifting columns. This obviates the need for separate batteries. According to the invention, providing the power line connection enables power line communication (PLC). Power Line Communication enables communication of data over the electrical grid connecting the individual lifting devices. This may relate to a dedicated electrical grid for a group of lifting devices, a workshop or factory, or may relate to the overall electrical grid. The data transfer between lifting devices is transferred as a superimposed signal on the electrical power signal that functions as carrier. Preferably, the frequency of this carrier wave is the frequency of the electrical grid, for example 50 or 60 Hz. The data transfer between lifting devices operates at other frequencies, for example at about 400 kHz with the use of orthogonal frequency division multiplexing (OFDM). It will be understood that other alternative techniques are available to multiplex the carrier wave with the data transfer and divide the multiplexed signal at its destination into a power signal and an information or data signal.

Providing a lifting system that is capable of using power line communication only requires standardized wiring between columns, for example three phase wiring. By connecting individual lifting devices directly or indirectly to the electrical grid no additional wires are required. This obviates the need for relatively expensive connectors. Furthermore, as compared to conventional wired lifting columns, the amount of wires is significant reduced. As compared to wireless lifting columns the robustness of the data transfer is significantly improved. Therefore, the lifting system using power line communication according to the invention provides an effective system for lifting a vehicle.

In a presently preferred embodiment according to the invention, the lifting system comprises a central power connection to the electrical grid that is configured for providing power to two or more lifting devices of the lifting system.

By providing a central power connection lifting devices can be indirectly connected to the electrical grid, thereby obviating need for an individual connection. For example, for each group of lifting devices one central power connection can be provided that provides power to all the associated lifting devices. Alternatively, the workshop is provided with a central power connection and all lifting devices in the workshop, including devices that are part of the lifting system or are excluded from the lifting system, are connected to the central power connection.

In an alternative embodiment, lifting devices are coupled in sub-groups and connected to a sub-central power connection that is connected to the electrical grid. For example, all lifting devices on one side of the vehicle to be lifted can be connected to the sub-central power connection, while the lifting device is on the other side of the vehicle to be lifted are connected to a different sub-central power connection. This reduces the need for wiring between lifting devices.

In a further alternative embodiment according to the present invention the individual lifting devices comprise an individual power connection to the electrical grid.

By providing the individual lifting devices with an individual power connection flexibility is optimized. These lifting devices with individual power connections can be advantageously used in a workshop that require flexible lifting systems capable of selecting the required number of lifting devices in a lifting system depending on a vehicle to be lifted.

In a preferred embodiment according to the present invention the lifting devices comprise a control circuit configured for splitting a communication signal from the power transmission.

By providing the lifting devices with a control circuit the communication signal from the control system can be divided or de-multiplexed from the signal that is received. It will be understood that the data transmission can be addressed to specific lifting columns such that only that specific lifting column is capable of de-multiplexing the signal. This provides a robust and safe data transfer.

In a further preferred embodiment according to the present invention at least some of the lifting devices of the lifting system comprise moving elements configured to enable movement of the lifting device.

By providing moving elements, the lifting devices, particularly a lifting column, can be moved over some distance. In case the lifting device is connected to the electrical grid, the freedom to move will be limited. However, depending on the configuration of the power connection some manoeuvring of the lifting device could be enabled thereby providing flexibility for positioning the lifting device relative to the vehicle to be lifted. In case the power connection for a lifting device is disconnected the moving elements enable the lifting device to be moved across the workshop, for example. This enables operating the lifting device more as a mobile lifting device, such as a mobile lifting column. This provides the flexibility of wireless lifting devices to the lifting system according to the present invention. Only the power connection has to be disconnected where after movement of the lifting device is possible.

In a further preferred embodiment according to the present invention the control system comprises a lifting device selector configured for selecting lifting devices for the lifting system.

By providing the control system with a lifting device selector the number of lifting devices in the lifting system can be adapted and brought into conformity with the vehicle to be lifted. It will be understood that the actual selection of lifting columns can be made in many different ways. As an example, a selection method is disclosed in U.S. 2006/0115353. It will be understood that other selection procedures could also be applied in accordance with the present invention.

In a further preferred embodiment according to the present invention the control system comprises a central controller configured for controlling the lifting devices of the lifting system.

The central controller is capable of determining and communicating required control actions to the individual lifting devices. The central controller can be positioned in or at an individual lifting device or separately from the lifting devices. For example, the central controller can be positioned above the group of lifting devices that it is controlling. This may involve attaching the central controller to a ceiling of the workshop, for example. This could be advantageous in case the power line connection is also provided above the group of lifting devices. This further reduces the length of wires that is required. A further advantage of working with a central controller is obviating the need to provide individual lifting devices with computing means, thereby reducing the complexity and associated cost of individual lifting devices. Optionally, the central controller is capable of controlling multiple groups of selected lifting devices, such as two, three, four or more groups. For example, a workshop with a number of flexible lifting systems can be controlled by an individual central controller using power line communication.

In a further preferred embodiment according to the present invention the control system comprises a communication connector configured for communication with external networks.

By providing a communication connector enabling communication with external networks, the flexibility of the lifting system according to the present invention is further improved. Examples of coupling lifting devices with an external network are described in WO 2015/005772, for example. Such external networks may involve one or more of the following: workshop networks for scheduling workshops, financial networks for billing purposes, service and maintenance networks, for example.

Often, lifting devices, such as lifting columns, can be used freely by a user. In some of the conventional systems a user requires an identification enabling the user to control the lifting system. Although this identification of the user enables monitoring the user, and to some extent guarantees the use of the lifting system by authorised personnel only, the correct use of the lifting system by an identified and/or authorised user cannot be guaranteed under all circumstances. In practice, this may lead to unneeded lifting operations or even undesired lifting operations that may reduce the life span of the lifting system and/or increase maintenance costs. In addition, undesired lifting operations may even lead to safety concerns. Enabling a connection of the lifting system with an external (workshop) network, monitoring and/or control of the actual use of the lifting system can be advantageously applied. For example, this enables monitoring and/or control of the lifting system in view of the lifting costs of the lifting system as a whole and/or lifting costs of an individual lifting operation for a specific vehicle, for example.

Enabling communication between the controller of the lifting system, optionally the central controller, and external networks provides remote servicing of the lifting system. This may even involve remote control of the lifting system. For example, the manufacturer of the lifting system may service the lifting system remotely involving regular maintenance and/or trouble shooting.

Furthermore, enabling communication between the control system and external networks provides additional logistic and scheduling benefits. For example, an operator may inform the logistics/scheduling department directly from the lifting system that a vehicle is ready to be used. This may significantly reduce the time period a vehicle is not available. This is especially relevant for vehicles that are commercially used, such as busses and refuse trucks. Also, an operator may directly inform (governmental) organizations that a vehicle is ready for inspection, for example for a general periodic check (for example the APK according to regulations in The Netherlands). Enabling communication between the central controller and external networks reduces the time period that a vehicle is not available for use.

By enabling communication with an external network the lifting system can be provided with a clearance signal such that the lifting system can be put into operation. After receipt of the clearance signal the release system may release the lifting system involving a release system, for example by releasing a clamp of the carrier thereof and/or by releasing a software stop, thereby enabling a lifting operation. The release system may involve locking and/or unlocking means. Examples thereof include software locks locking the use of a pump or motor and hardware locks physically blocking movement of the carrier. Preferably, the release system responds to a clearance signal or an absence of such clearance signal. The clearance signal can be sent to the input of the controller by the clearance system that can be physically located attached to or adjacent the lifting system, or also remotely. The clearance signal can be sent to the controller through power line communication or alternatively through a wired connection or a wireless connection.

Optionally, the clearance signal is generated after receiving a payment for performing the required lifting operation. This payment can be received through a pre-paid card that is offered to the lifting system directly at the lifting device and/or at the clearance system. Alternatively, or in addition thereto, the clearance system provides an authorisation to perform a number of lifting operations, optionally in a specific time period. Furthermore, the clearance system may send a clearance signal and collect the data such that debit information can be provided to the accountant/billing department and/or debit the client directly. This enables a direct coupling of the lifting operation to the (end)-user. This renders the use of the lifting system according to the present invention cost controlled, thereby further preventing undesired and/or unneeded lifting operations. Furthermore, this provides the opportunity and possibility for operational leasing or renting the lifting system according to the present invention and pay for a specific lifting operation as an alternative to, or in addition to, a payment for the lifting system as such.

Furthermore, monitoring the movements of the lifting system enables a direct coupling of a lifting operation for a specific vehicle to the costs associated with using the lifting system according to the present invention. The coupling to external networks also enables direct debiting of the vehicle owner for usage of the lifting system, a type of so-called pay-per-lift debiting system.

The invention further relates to a method for controlling a lifting system for lifting a vehicle comprising the steps of:
providing a lifting system as described above; and
controlling the lifting system with the controller involving power line communication.

The same effects and advantages apply for the method as described for the lifting system.

Further advantages, features and details of the invention will be elucidated on the basis of preferred embodiments thereof, wherein reference is made to the accompanying drawings, in which:

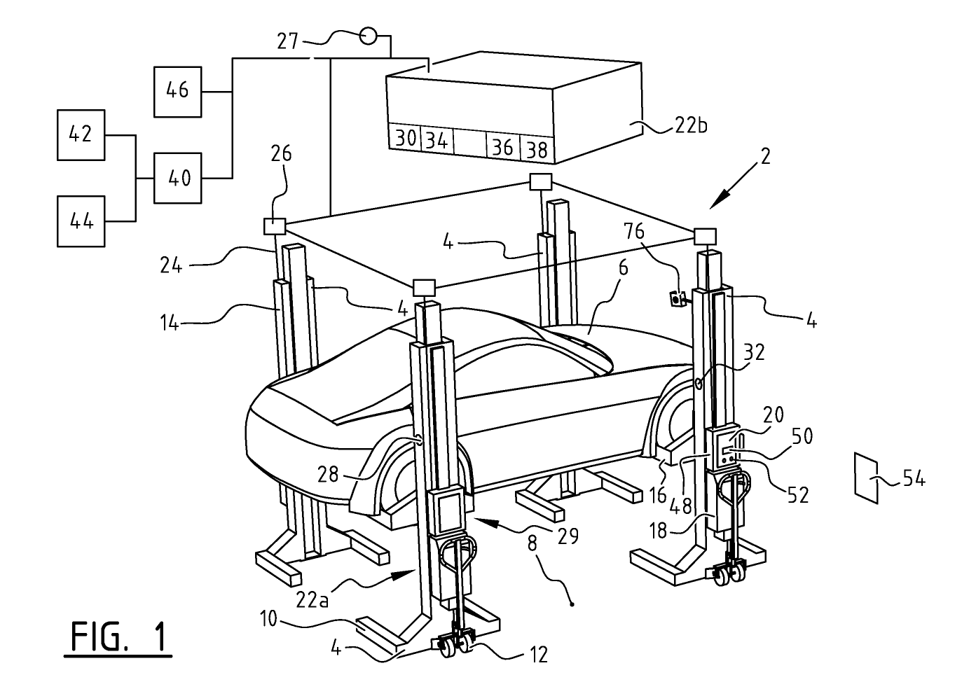

FIG. 1 shows a schematic overview of a lifting system according to the invention;

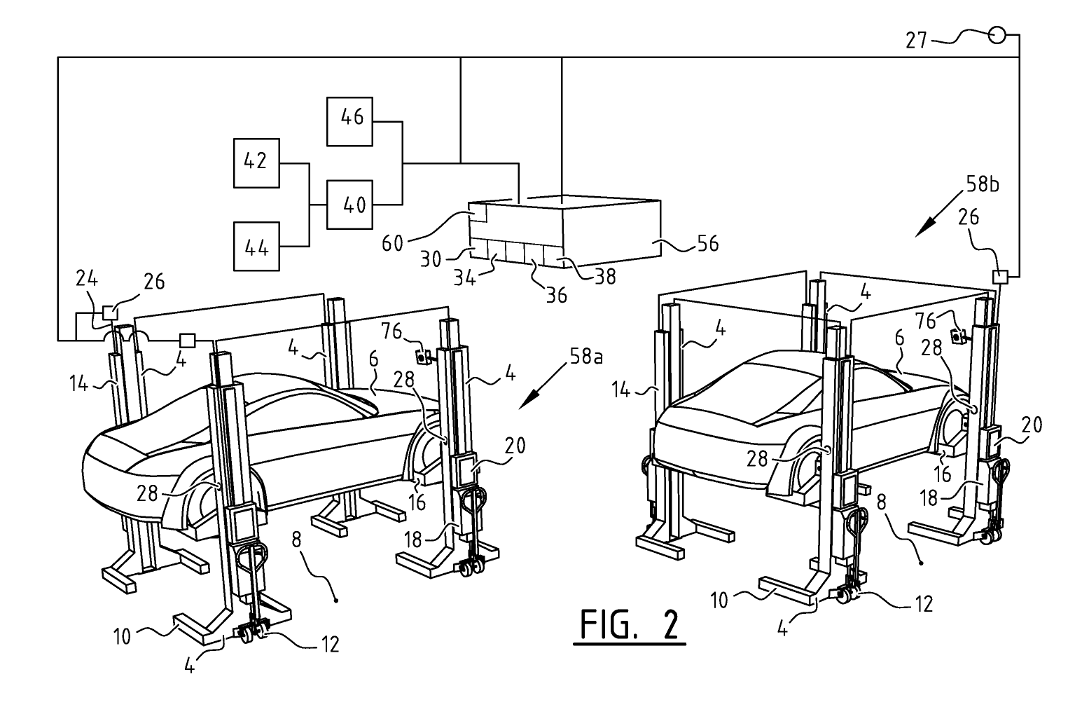

FIG. 2 shows an alternative system with a central group controller;

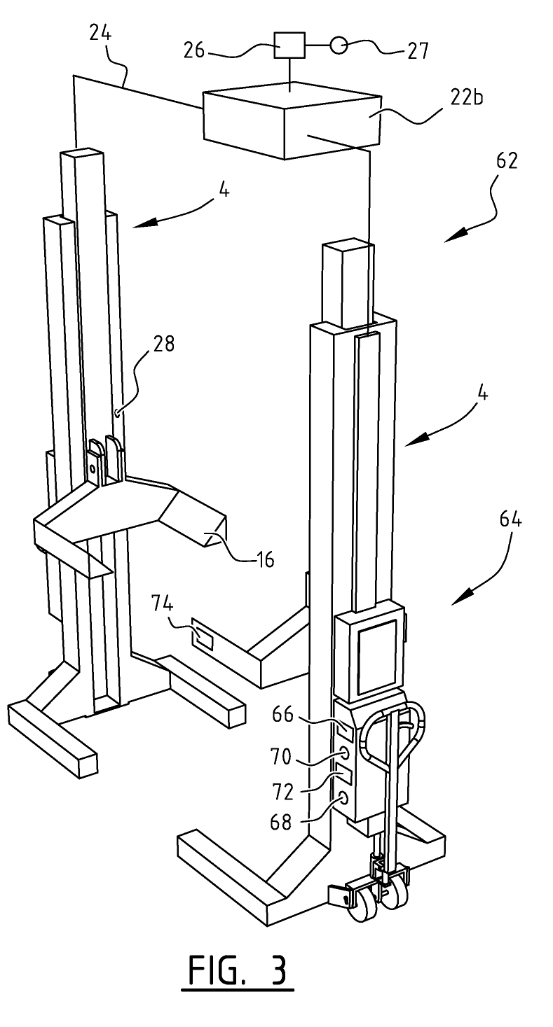

FIG. 3 shows a further alternative lifting system according to the invention with two lifting columns and a release system; and

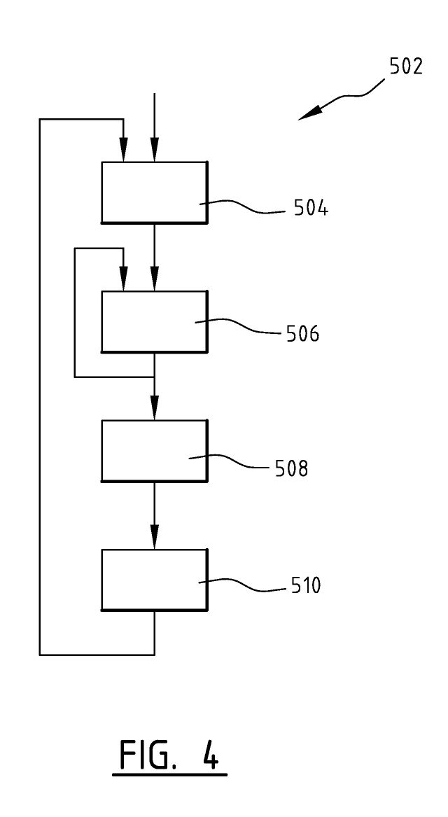

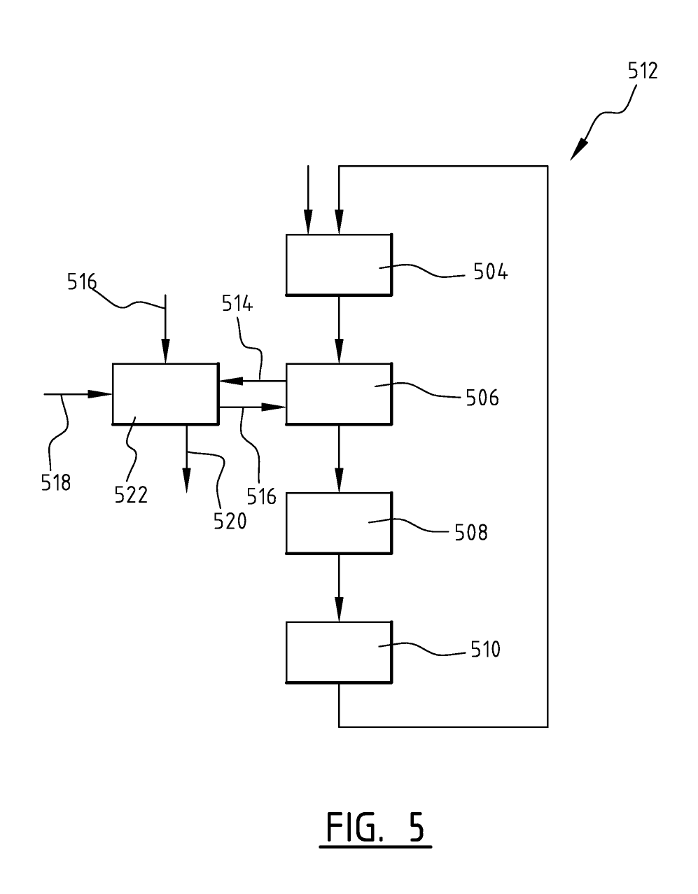

FIGS. 4-5 show pay-per-lifts method according to the invention.

The following description is merely exemplary in nature and is in no way intended to limit the invention, its application, or uses. While the disclosure is described as having exemplary attributes and applications, the present disclosure can be further modified. This application is therefore intended to cover any variations, uses, or adaptations of the disclosure using its general principles. Further, this application is intended to cover such departures from the present disclosure as come within known or customary practice of those skilled in the art to which this disclosure pertains and which fall within the limits of the appended claims. Accordingly, the following description of certain embodiments and examples should be considered merely exemplary and not in any way limiting.

The lift control system of the present invention is suitable for use with lift systems comprising any number of lifting devices that require height control columns, including systems having one, two, four or another number of columns. The columns may achieve lifting and lowering capability by any means known to those of skill in the art, including hydraulically, electrically, mechanically, and electromechanically. Lift systems compatible with the present lift control system may be stationary and/or permanently affixed or attached to a certain location or may be mobile, capable of being transported via wheels or any other suitable means known to those in the art. With reference to the figures, like element numbers refer to the same element between drawings.

Lifting system 2 (FIG. 1) comprises four mobile lifting columns 4 in the illustrated embodiment. Lifting columns 4 lift passenger car 6 from ground 8. Lifting columns 4 comprise foot 10 which can travel on running wheels 12 over ground surface 8 of for instance a floor of a garage or workshop. In the forks of foot 10 there is provided an additional running wheel (not shown). Lifting column 4 further comprises mast 14. A carrier 16 is moveable upward and downward along mast 14. Carrier 16 is driven by a motor-pump assembly 18 that is provided in a housing of lifting column 4. Display unit 20 may provide the user with information about the lifting system.

Control system 22 for lifting system 2 can be implemented as individual controllers 22a and/or as central controller 22b. Power is supplied to individual lifting columns 4 with power lines 24 that are connected with connectors 26 to electrical grid 27. In the illustrated embodiment lifting devices 4 of lifting system 2 are provided with individual connectors 26. Communication that is received by an individual lifting column 4 over power line 24 is de-multiplexed with circuit 29 that is preferably included in controller 22a. In an embodiment comprising a central controller 22b such multiplexing and/or de-multiplexing circuit 30 is preferably provided in central controller 22b.

In the illustrated embodiment connectors 26 are provided above lifting columns 4, optionally together with central controller 22b. It will be understood that another configurations of power lines 24 could also be envisaged in accordance with the present invention. For example, power lines 24 can be laid over the workshop floor, although it is preferred to provide power lines 24 inside the workshop floor 8. It will be understood that providing connector 26 and power lines 24 above lifting columns 4 provides a presently preferred embodiment of lifting system 2. By connecting power lines 24 with some play or clearance to lifting column 4, some freedom to move or maneuver an individual lifting column 4 is provided using wheels 12. In the illustrated embodiment such control of lifting system 2 can be centralized with central controller 22b, or by choosing one of the individual local controllers 22a as master controller, or can be decentralized by cooperating local controllers 22a of different lifting columns 4, or involves a combination of central and decentral control.

The control system in the different embodiments may receive measurement signals representing the actual height of a carrier 16 of an individual lifting column 4 that is measured with sensor 32. Sensor 32 is capable of measuring position and/or speed of carrier 16 and can be a potentiometer and/or an inclinometer and/or other suitable measuring device. When height differences between lifting columns 4 are detected, required control actions are calculated with computing means 34 that can be provided in central controller 22b and/or in one or more local controllers 22a. The required control actions are transferred to one or more of the lifting columns 4 using power line communication over power lines 24 and are de-multiplexed using circuit 29. Data can be stored in memory 36. External connector 38 enables connection to internal and/or external networks, for example involving internal company networks for workshop control 40, networks for financial control 42, maintenance networks 44, and networks for suppliers and customers 46.

In the illustrated embodiment display unit 20 comprises housing 48, display 50, such as a touchscreen, buttons 52 and ID-key and/or pre-paid card 54. Display 24 can be attached to one or more individual lifting columns 4 and/or can be a portable hand held unit.

In lifting system 2 a number of lifting columns 4 are selected and incorporated in a group of lifting columns 4 together forming a lifting system 2. This may involve the use of key or card 54 for example. Optionally, the lifting columns 4 are selected with user display unit 20 and lifting system 2 can be provided with user instructions. The instructions are provided with power line communication over power lines 24 to individual lifting columns 4 that are selected for lifting system 2. Then operation of lifting system 2 can be started.

In an alternative embodiment central controller 56 (FIG. 2) is capable of controlling multiple groups of lifting systems 58a, 58b. In the illustrated embodiment lifting columns 4 of system 58a are coupled in pairs to the electrical grid with power lines 24 and connectors 26. In lifting system 58b the entire group of selected lifting columns 4 is connected with a central connector 26 to the electrical grid. Optionally, central controller 56 comprises separate computing means 60 for the different groups of lifting systems 58a, 58b.

A further alternative embodiment lifting system 62 (FIG. 3) comprises two individual lifting columns 4 that are connected to central controller 22b or central unit with power lines 24. In the illustrated embodiment lifting system 62 is connected with central connector 26 to the electrical grid 27. Lifting system 62 comprises release system 64.

In the illustrated embodiment controller 22a, 22b provides a clearance signal to an individual lifting column 4 involving a release signal enabling the effective use of carrier 16. The release signal may release a software lock preventing motor 66 and/or pump 68 of lifting column 4 to operate. Alternatively, or in addition thereto, release signal may release a hardware lock, for example a clamp locking carrier 16. Payments can be received via card 54, generating payment instructions and sending the instructions to the accounting department of the user and/or receiving an authorization signal authorizing the system and user to perform a number of lifts and/or use lifting system 2 for a specific period of time.

It will be understood that the different configurations for power lines 24 and connectors 26 shown for the individual lifting systems 2, 58a, 58b, 62 can be exchanged with other embodiments that are shown or not shown. This enables a number of configurations for lifting systems according to the present invention, wherein the actual configuration of power lines 24 and connectors 26 and controllers 22a, 22b can be chosen, taking the specific requirements of an application into account.

Operation of lifting system 2 may involve method 502 (FIG. 4) starting with initiation step 504. In clearance step 506 the clearance check is performed. In case clearance is confirmed system 2 is released by the release system in release step 508 and lifting step 510 can be started to perform the desired lifting.

In an alternative method 512 (FIG. 5) clearance step 506 involves communication with a clearance system 522 involving a requesting step sending a request 514 for an authorization to use lifting system 2 and/or a reply step receiving a reply 516 relating to the authorization or denial to use lifting system 2. In order to send any authorization and/or clearance signals clearance system receives payments 516, for example with a pre-paid lift card 52, or payment confirmations 518, for example via an automatic debit order, and/or sends payment instructions 520.

Sensor 28 can be used to inform controller 22 of lifting activities of carrier 16. Alternatively, or in addition thereto, motor run time sensor 70 (FIG. 3) may provide controller 22a, 22b with motor run time information of motor 66 and/or pump activity sensor 72 may provide controller 22 with pump activity information of pump 68 and/or load sensor 74 may provide central controller 22 with information on the actual loads carried by carrier 16, preferably in combination with the time period the carrier 16 is exposed to the load.

Optionally, camera 76 (FIG. 1) provides information about the type of vehicle, such as a bus, truck or passenger car, to controller 22a, 22b enabling the controller to adjust the settings of lifting system 2 and/or use vehicle specific information for debiting the user for the lifting operation that is performed. Optionally, camera 76 detects the vehicle registration, for example by the license plates, optionally providing the relevant information to the accounting department such that the vehicle owner can be debited for the actual lifting operation(s).

The present invention can be applied to the lifting columns illustrated in the figures. Alternatively, the invention can also be applied to other types of lifting columns and lifting devices.

The present invention is by no means limited to the above described preferred embodiments. The rights sought are defined by the following claims within the scope of which many modifications can be envisaged. The present invention is described using a lifting device such as a lifting column and more specifically a moveable lifting column. The invention can also be applied to other type of lifting columns such as so-called boom-lifts, scissor-lifts and loading platforms. Such lifting equipment can be provided with the measures illustrated above according to the invention.

1-10. (canceled)

11. A lifting system for lifting a vehicle comprising one or more lifting devices, each lifting device comprising:
a frame with a carrier configured for carrying the vehicle;
a drive for driving the carrier in at least one of the ascent or descent of the carrier; and
a power line connection for providing power to the lifting device;
wherein the lifting system further comprises:
a control system configured for establishing communication with one or more of the lifting devices,
wherein the communication comprises power line communication.

12. The lifting system according to claim 11, further comprising a central power connection to an electrical grid configured for providing power to two or more lifting devices of the lifting system.

13. The lifting system according to claim 11, wherein individual lifting devices comprise an individual power connection to an electrical grid.

14. The lifting system according to claim 11, wherein the lifting devices comprise a control circuit configured for splitting a communication signal from a power transmission.

15. The lifting system according to claim 11, wherein at least some of the lifting devices of the lifting system comprise moving elements configured to enable movement of the lifting device.

16. The lifting system according to claim 11, wherein the control system comprises a lifting device selector configured for selecting lifting devices for the lifting system.

17. The lifting system according to claim 11, wherein the control system comprises a central controller configured for controlling the lifting devices of the lifting system.

18. The lifting system according to claim 17, wherein the central controller controls two or more independent groups of selected lifting devices.

19. The lifting system according to claim 11, the lifting system comprising two or more lifting columns.

20. The lifting system according to claim 11, wherein the control system comprises a communication connector for communication with external networks.

21. The lifting system according to claim 11, wherein data is transferred as a superimposed signal on an electronical power signal that functions as carrier.

22. The lifting system according to claim 14, wherein data is transferred as a superimposed signal on an electronical power signal that functions as carrier.

23. The lifting system according to claim 12, wherein the lifting devices comprise a control circuit configured for splitting a communication signal from a power transmission.

24. The lifting system according to claim 13, wherein the lifting devices comprise a control circuit configured for splitting a communication signal from a power transmission.

25. The lifting system according to claim 21, the lifting system comprising two or more lifting columns.

26. A lifting system for lifting a vehicle comprising one or more lifting devices, each lifting device comprising:
a frame with a carrier configured for carrying the vehicle;
a drive for driving the carrier in at least one of the ascent or descent of the carrier; and
a power line connection for providing power to the lifting device;
wherein the lifting system further comprises:
a control system configured for establishing communication with one or more of the lifting devices,
wherein the communication comprises power line communication, wherein the lifting devices comprise a control circuit configured for splitting a communication signal from a power transmission, the lifting system comprising two or more lifting columns.

27. The lifting system according to claim 26, wherein the central controller controls two or more independent groups of selected lifting devices.

28. The lifting system according to claim 27, wherein the control system comprises a communication connector for communication with external networks.

29. A method for controlling a lifting system for lifting a vehicle, comprising:
providing a lifting system according to claim 11;
controlling the lifting system with the control system involving power line communication.

30. The method of claim 29, further comprising providing a control circuit configured for splitting a communication signal from a power transmission, wherein the lifting system comprises two or more lifting columns.
